(19) United States
(12) Patent Application Publication
(10) Pub. No.: US 2011/0283862 A1
(43) Pub. Date: Nov. 24, 2011

(54) Flare pick

(76) Inventor: Toddington S. Tracy, Englewood, FL (US)

(21) Appl. No.: 12/800,715

(22) Filed: May 21, 2010

(51) Int. Cl. G10D 3/16

(52) U.S. Cl. 84/322

(57) ABSTRACT

The flare Pick is a dimensional guitar pick used for playing a variety of stringed instruments that are typically strummed or where individual notes are “picked”. The pick's unique side index finger indentation allows the inside edge of the users index finger to form fit into the picks body. The opposing thumb is pressed against the back of the pick firmly locking the pick into position. The stability of the picks design prevents slippage or rotating while in use and provides a stable and dependable orientation for proper string/pick engagement. The size, flexibility and depth of indentation can vary to accommodate all types of playing styles and finger sizes.

### FIELD OF THE INVENTION

The invention relates to stringed instruments like guitars, banjos, mandolins, bass guitars, ukuleles, etc. where the player uses a pick for a clean crisp consistent sound, not typically achieved when strings are strummed or plucked using fingers. Playing a stringed instrument can be challenging enough without the constant trial of keeping a pick under control. Proper pick orientation, string engagement depth and rotational stability are key factors for sound quality.

### DESCRIPTION OF THE PRIOR ART

There has been dozens of attempts over the years to solve the instability issues inherently found in the typical flat pick design. Picks tend to wander in the players fingers during playing for several reasons: sweat causes the plastic material to become slippery, while cold tends to dry out the players fingers causing pick instability. Rotation is the most common problem with flat picks but string engagement dept can be equally important for lead players. Common solutions included flat pick dimples, pick textures, alignment notches or holes, distinctive shapes and even pick clip on accessories or extensions. Most of the recorded art focused on a tactile feedback for the player to interpret and manage while the Flare Pick design simply fits into the fingers' grip and remains firmly fixed in place without interaction from the player. The dimpled area engages the side of the player's index finger while the opposing raised surface molds itself into the players thumb locking both the picks string engagement depth and angle eliminating all the annoying instabilities normally found in a flat pick.

For example, U.S. Pat. No. 6,417,431 B1 uses a surface that “protrudes above the surface and incorporates a circular bevel region surrounding a center hole along with a plurality of grip protrusions from said bevel region enabling the player to retain a firm grasp upon the pick” The raised protrusion concept is limited, it helps but it's only part of the answer. U.S. Pat. No. 6,054,643 attempted to solve the pick stability issue by using a clip on finger cradle. First of all, the clip's engagement angle on the player's fingers is wrong for the typical player and second the clip itself adds additional permanency and stability variables for the player to overcome. U.S. Pat. No. 6,127,613 took the stability issue one step too far incorporating an extending pick that anchored itself to the player's index finger. This elongated design limits the versatility of a traditional flat pick and looks to be clumsily impractical for the typical player.

The Flare Pick overcomes all of the for mentioned design flaws with one simplistic addition to the standardized flat pick, the side index finger molded dimple. With this dimensional addition the flat pick is stabilized in the players grip in all climates; wet, dry, hot or cold. No gimmicks, no complicated extras, just a simple pressing process transforms the limited flat pick that has served the world so well into the perfect pick, the Flare Pick.

### SUMMARY OF INVENTION

It is the object of the present invention, the Flare Pick, to provide a stable and dependable interface between the player's fingers and the musical instrument's strings. The unique but simple shape of the Flare Pick engages the side of the player's index finger in the form fitting indentation which is in turned lock in place on the corresponding raised side by the opposing thumb. Once engaged in the player's fingers the Flare Pick is practically immobile and requires no attention from the player. The design overcomes rotational issues while establishing a standardized string engagement depth and remains comfortably fixed in place even after extended playing or climate extremes. The Flare Pick design can easily be rescaled and pressed into any of the standardized open market flat picks.

### BRIEF DESCRIPTION OF THE SEVERAL VIEWS OF THE DRAWINGS

FIG. 1 Is an end of view depicting the Pick dimensions and depth of the indentation

FIG. 2 Is a side view of the Pick according to the invention.

FIG. 3 Is a frontal view in proportion to FIG. 1 & FIG. 2 according to the invention.

FIG. 4 Is an isometric view of the Pick as it would lie on a table.

FIG. 5 Is a view of the grip of the Pick in use.

### DETAILED WRITTEN DESCRIPTION

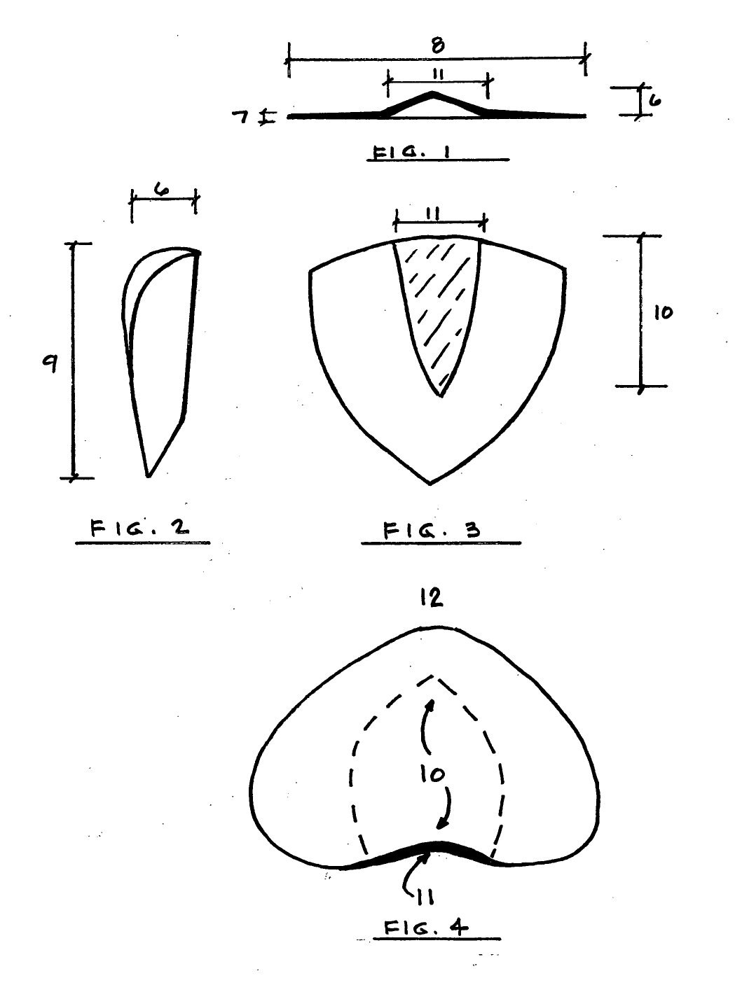

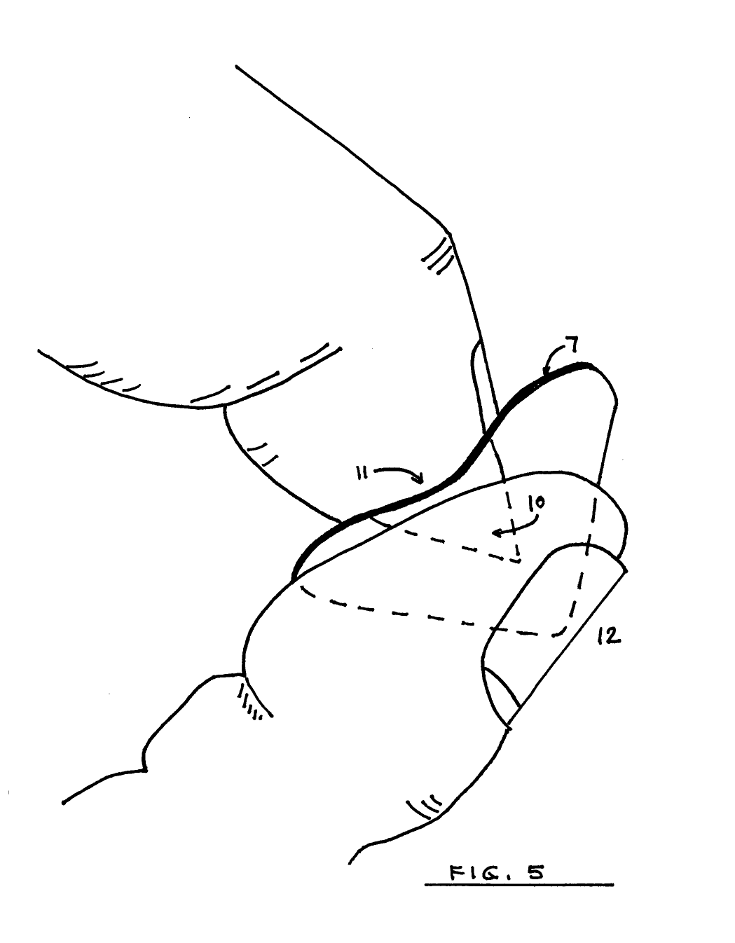

FIG. 1, FIG. 2 and FIG. 3 show the Pick or Plectrum's overall dimensions of approximately 1-¼″×1-¼″ and is typically triangular in shape with rounded edges. Dimensions will vary between manufactured models supporting individual's preferences of flexibility and size.

FIG. 1, depicts the Pick's indentation #6, the thickness #7 and the overall width #8.

FIG. 2, the side view shows again the depth the indentation #6 and the overall length #9.

FIG. 3, the front view shows the length of the indentation #10 and the width of the indentation #11.

FIG. 4, depicts the pronounced indentation #10 & #11, which provides the rotational stability and proper grip depth of the Pick.

FIG. 5, is a sketch of the Pick in use viewing the thumb and forefinger properly aligned gripping the Pick's indentation #10 & #11. Item #7 is the Pick's thickness and #12 is the leading edge or the string engagement point.

The unitary Pick may be made from a variety of materials including nylon or deldrin that provide different levels of thickness and flexibility, both materials are suitable for manufacturing using a liquid injection or press molding process.

What is claimed is:

1. The unique but simple shape of the Pick's form fitting indentation engages the side of the player's index finger which is locked firmly in place by the opposing thumb on the corresponding raised surface. This locking grip design provides the user with (1) rotational pick stability, (2) pick orientation control and (3) string engagement depth. The flare Pick design can be easily rescaled to support individual preferences of flexibility and size.
